(19) United States
(12) Patent Application Publication
(10) Pub. No.: US 2024/0257190 A1
(43) Pub. Date: Aug. 1, 2024

(54) INFORMATION RETRIEVAL SYSTEM AND INFORMATION RETRIEVAL METHOD

(71) Applicant: Toshiba Tec Kabushiki Kaisha, Tokyo (JP)

(72) Inventor: Hiroshi SHIMOMURA, Mishima Shizuoka (JP)

(21) Appl. No.: 18/502,587

(22) Filed: Nov. 6, 2023

(30) Foreign Application Priority Data
Jan. 26, 2023 (JP) 2023-010546

(51) Int. Cl. G06Q 30/0282

(52) U.S. Cl. CPC G06Q 30/0282; G06Q 50/01

(57) ABSTRACT

According to an embodiment, an information retrieval system detects a product that is identified by product identification information stored in association with user identification information, from the information posted by a posting-person site of a posting-person identified by posting-person identification information stored in association with the user identification information. The information retrieval system detects sales information of the detected product from a store site that provides sales information of various products.

### CROSS-REFERENCE TO RELATED APPLICATIONS

This application is based upon and claims the benefit of priority from the prior Japanese Patent Application No. 2023-10546, filed on Jan. 26, 2023, the entire contents of which are incorporated herein by reference.

### FIELD

Embodiments described herein generally relate to an information retrieval system and a retrieval method therefor.

### BACKGROUND

With the popularization of the Internet in recent years, consumers have become able to obtain various types of information related to products by using information terminals such as personal computers and smartphones. In particular, there has been recently an increasing dependency on posting-persons who use the function of a social networking service (SNS) to post information, i.e., influencers, and an increasing number of consumers searches for products of interest on the basis of the information posted by influencers whose interests and preferences match with those of the consumers. However, the actual situation is that consumers have difficulty of immediately reaching information of stores that sell the products of interest on the basis of only the information posted by the influencers.

### BRIEF DESCRIPTION OF THE DRAWINGS

FIG. 1 is a system configuration diagram of an information retrieval system according to an embodiment.

FIG. 2 is a block diagram of a circuit configuration of a main part of an information retrieval server according to the embodiment.

FIG. 3 is a schematic diagram showing main data items that constitute a posting-person record according to the embodiment.

FIG. 4 is a schematic diagram showing main data items that constitute a user record according to the embodiment.

FIG. 5 is a block diagram showing a circuit configuration of a main part of an information terminal according to the embodiment.

FIG. 6 is a flowchart showing main information processing that is executed according to an information retrieval application by a processor of the information terminal according to the embodiment.

FIG. 7 is a flowchart showing main information processing that is executed according to the information retrieval application by the processor of the information terminal according to the embodiment.

FIG. 8 is a flowchart showing main information processing that is executed according to the information retrieval application by the processor of the information terminal according to the embodiment.

FIG. 9 is a flowchart showing main information processing that is executed according to the information retrieval application by the processor of the information terminal according to the embodiment.

FIG. 10 is a flowchart showing main information processing that is executed in response to a registration event by a processor of the information retrieval server according to the embodiment.

FIG. 11 is a flowchart showing main information processing that is executed in response to a deletion event by the processor of the information retrieval server according to the embodiment.

FIG. 12 is a flowchart showing main information processing that is executed in response to a retrieval event by the processor of the information retrieval server according to the embodiment.

FIG. 13 is a flowchart showing main information processing that is executed in response to an execution event by the processor of the information retrieval server according to the embodiment.

FIG. 14 is a schematic diagram showing a display example of a menu screen according to the embodiment.

FIG. 15 is a schematic diagram showing a display example of a registration completion list screen according to the embodiment.

FIG. 16 is a schematic diagram showing a display example of a posting-person list screen according to the embodiment.

FIG. 17 is a schematic diagram showing a display example of the registration completion list screen according to the embodiment.

FIG. 18 is a schematic diagram showing a display example of a product input screen according to the embodiment.

FIG. 19 is a schematic diagram showing a display example of a product introduction screen according to the embodiment.

FIG. 20 is a schematic diagram showing a display example of a sales information screen according to the embodiment.

### DETAILED DESCRIPTION

According to one embodiment, an information retrieval system includes an information terminal, a posting-person site, a store site, and an information retrieval server. The information terminal is connected to a network and used by a consumer to search for a product. The posting-person site is connected to the network and used by a posting-person to post information of a product. The store site is connected to the network and used by a store to provide sales information of various products. The information retrieval server is connected to the network. The information retrieval server stores posting-person identification information for identifying the posting-person and product identification information for identifying a product to be retrieved in association with user identification information for identifying the consumer. The information retrieval server detects the product identified by the product identification information stored in association with the user identification information, from information that is posted via the network by the posting-person site of the posting-person identified by the posting-person identification information stored in association with the user identification information. The information retrieval server detects sales information of the detected product from the store site. The information retrieval server outputs the sales information of the detected product to the information terminal used by the consumer identified by the user identification information.

Hereinafter, an embodiment of an information retrieval system capable of retrieving a product of interest to a consumer from information posted by a posting-person preferred by the consumer and further retrieving sales information of the product will be described with reference to the drawings. In the drawings, the same reference symbols denote the same or similar parts.

### Description of Information Retrieval System

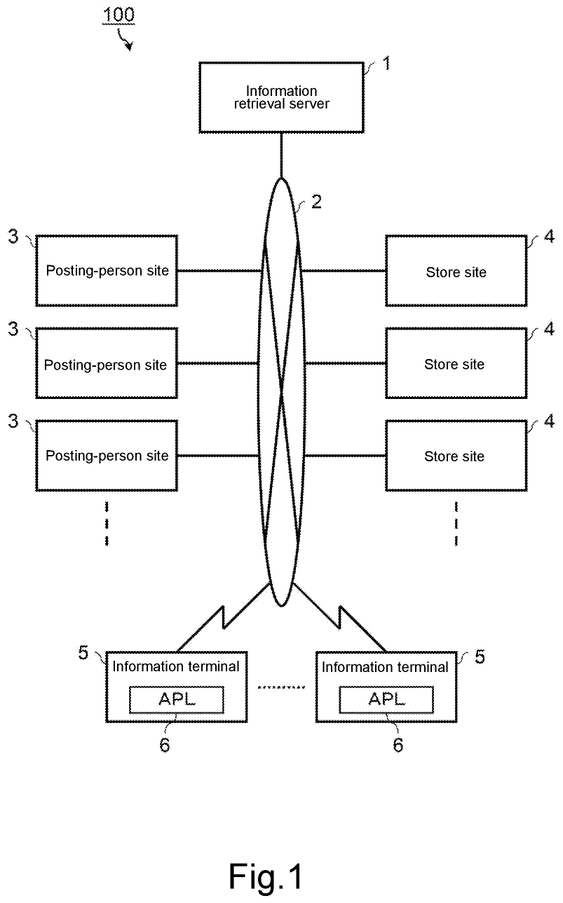

FIG. 1 is a system configuration diagram showing an information retrieval system 100 according to an embodiment. The information retrieval system 100 includes an information retrieval server 1 and a communication network 2. The information retrieval server 1 is connected to the communication network 2. The communication network 2 is typically the Internet. A plurality of posting-person sites 3 and a plurality of store sites 4 are connected to the communication network 2. Further, a large number of information terminals 5 can be connected to the communication network 2 through a wireless local area network (LAN), for example.

The posting-person site 3 is a web site provided by a person who posts information (posting-person of information). The posting-person uses SNS functions such as Facebook (registered trademark), Twitter (registered trademark), Instagram (registered trademark), and YouTube (registered trademark) to post information of a product that the posting-person wants to introduce to consumers by using moving images or still images. The genre of products is not particularly limited. The posting-person has a significant influence on the willingness to buy of consumers, and are thus referred to as an influencer. In general, celebrities such as athletes, entertainers, fashion models, and specialists in specific fields can be influencers.

The store site 4 is a web site provided by a store. The store may be an actually existing store or a virtual store on the Internet. The store uses the store site 4 to post information of a product to be sold. Examples of the information of a product include an appearance image of a product, a product number, a product name, a manufacturer name, and a price. The genre of products is not particularly limited.

The information terminal 5 is a general-purpose terminal having a function of outputting information publicly available on web sites such as the posting-person site 3 and the store site 4. In other words, the information terminal 5 is a terminal that selectively implements application software corresponding to social networking services (SNS) such as Facebook, Twitter, Instagram, and YouTube, in addition to application software serving as a web browser. In this embodiment, the information terminal 5 implements dedicated application software for accessing the information retrieval server 1 through the communication network 2. Hereinafter, such dedicated application software will be referred to as information retrieval application 6. A general consumer is a user of the information terminal 5. For example, a smartphone, a personal computer, a tablet terminal, or the like can be the information terminal 5.

The information retrieval server 1 is a computer having a function of retrieving a product of interest to a consumer from among information posted from a posting-person site 3 of an influencer preferred by the consumer, using the information terminal 5, and further retrieving sales information of the product from the store site 4. The sales information is, for example, information of a store that sells the product.

In one embodiment, the consumer uses the information terminal 5 to register an influencer whose interests and preferences match with those of the consumer, and also to register genres of products that the consumer is interested in. The information retrieval server 1 uses the functions of SNS such as Facebook, Twitter, Instagram, and YouTube to retrieve information, which is posted through the communication network 2, from the posting-person site 3 of the influencer registered by the consumer. When detecting a product belonging to the genre registered by the consumer, the information retrieval server 1 extracts information of a store site 4 by, for example, a technique of web scraping. The information retrieval server 1 uses, for example, the technology such as image recognition or text mining using artificial intelligence (AI), to retrieve a store that sells the product detected from the posting-person site 3. The information retrieval server 1 outputs the information of the store acquired by the retrieval, that is, the sales information of the product, which is introduced by the influencer registered by the consumer and belongs to the genre registered by the consumer, to the information terminal 5 used by that consumer. According to such an embodiment, if an influencer having interests and preferences that match with those of a consumer introduces a product that the consumer is interested in, the consumer can acquire, through the information terminal 5, sales information such as information of a store at which the product is sold. In this regard, the configurations and actions of the information retrieval server 1 and the information terminal 5 according to the embodiment will be described below in detail.

### Description of Configuration of Information Retrieval Server

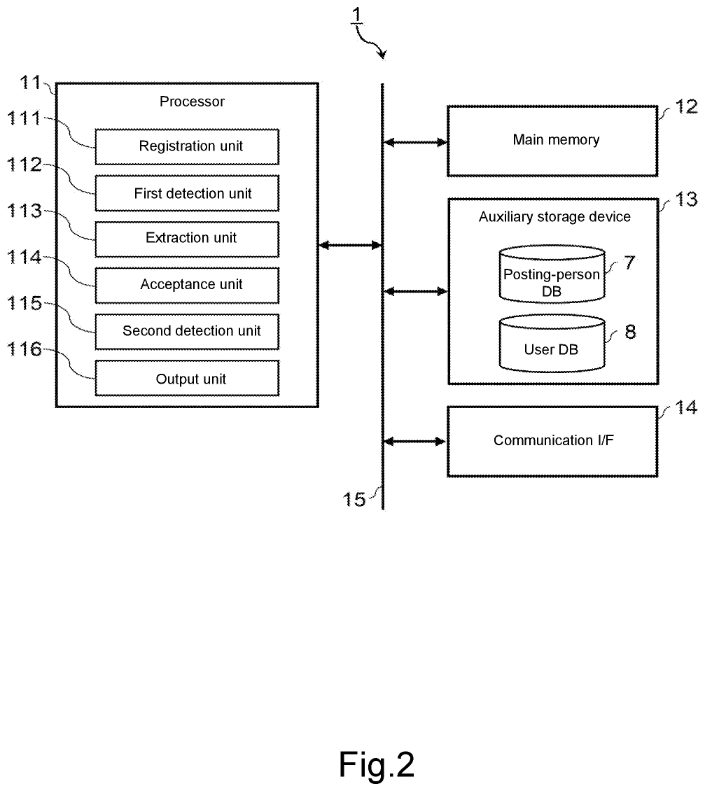

FIG. 2 is a block diagram showing a circuit configuration of a main part of the information retrieval server 1. The information retrieval server 1 includes a processor 11, a main memory 12, an auxiliary storage device 13, a communication interface 14, and a system transmission path 15. The system transmission path 15 includes an address bus, a data bus, a control signal line, and the like. The information retrieval server 1 constitutes a computer by connecting the processor 11, the main memory 12, the auxiliary storage device 13, and the communication interface 14 to each other via the system transmission path 15.

The processor 11 corresponds to the central portion of the computer. The processor 11 controls the units so as to implement various functions as the information retrieval server 1 according to an operating system or an application program. The processor 11 is, for example, a central processing unit (CPU).

The main memory 12 corresponds to a main storage portion of the computer. The main memory 12 includes a nonvolatile memory area and a volatile memory area. The main memory 12 stores the operating system or application software in the nonvolatile memory area. The main memory 12 may store data, which is necessary for the processor 11 to execute processing for controlling the units, in the nonvolatile or volatile memory area. The volatile memory area of the main memory 12 is used as a work area in which data is appropriately rewritten by the processor 11. The nonvolatile memory area is, for example, a read only memory (ROM). The volatile memory area is, for example, a random access memory (RAM).

The auxiliary storage device 13 corresponds to an auxiliary storage portion of the computer. For example, an electric erasable programmable read-only memory (EEPROM), a hard disk drive (HDD), a solid state drive (SSD), or the like can be the auxiliary storage device 13. The auxiliary storage device 13 stores data used by the processor 11 to perform various types of processing, data created in the processing by the processor 11, and the like. The auxiliary storage device 13 may store the application software.

The communication interface 14 is connected to the communication network 2. The communication interface 14 performs data communication with the posting-person site 3 or the store site 4 via the communication network 2. The communication interface 14 can also perform data communication with the information terminal 5 connected to the communication network 2.

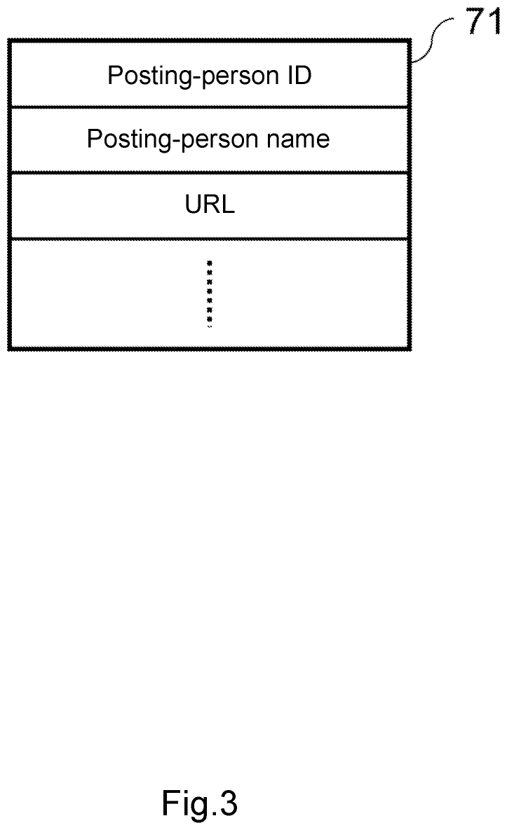

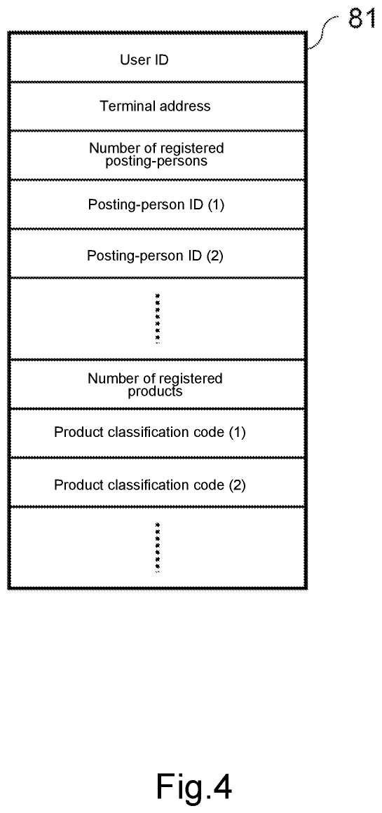

The information retrieval server 1 having such a configuration includes a posting-person database 7 and a user database 8 in the auxiliary storage device 13. The posting-person database 7 is an aggregate of posting-person records 71 created for each posting-person site 3 (see FIG. 3). The user database 8 is an aggregate of user records 81 created for each consumer who uses the information terminal 5 (see FIG. 4).

FIG. 3 is a schematic diagram showing main data items constituting the posting-person record 71. As shown in the figure, the posting-person record 71 includes a posting-person ID, a posting-person name, a uniform resource locator (URL) of a posting-person site 3, and the like. The posting-person ID is unique identification information, which is set for each posting-person to identify a posting-person having the posting-person site 3, that is, an influencer. The posting-person ID is an example of posting-person identification information. The posting-person name is a proper name of the posting-person identified by the posting-person ID. The URL is a URL of the posting-person site 3 provided by the posting-person.

FIG. 4 is a schematic view showing main data items constituting the user record 81. As shown in the figure, the user record 81 includes a user ID, a terminal address, the number of registered posting-persons, a posting-person ID, the number of registered products, a product classification code, and the like. The user ID is unique identification information, which is set for a consumer who has performed user registration so as to use the information retrieval system 100. The user ID is an example of user identification information. The terminal address is an IP address that is assigned to the information terminal 5 used by the consumer identified by the user ID. The number of registered posting-persons is a total number of posting-persons registered by the consumer. For example, the consumer can appropriately select and register a posting-person who has interests and preferences that match with those of the consumer from the posting-persons having the posting-person sites 3. The user record 81 includes the posting-person IDs corresponding to the number of registered posting-persons.

The number of registered products is a total number of products registered by the consumer. The products are classified into units of product classifications, in each of which similar items is set as a group. For example, fashion-related products are classified into genres such as tops, bottoms, footwear, and accessories. The tops is a product classification in which items such as shirts, jackets, and coats are set as a group. The bottoms is a product classification in which items such as slacks, skirts, and jeans are set as a group. The footwear is a product classification in which items such as sneakers, leather shoes, boots, and sandals are set as a group. The accessories is a product classification in which items such as wristwatches, necklaces, pendants, and earrings are set as a group. In one embodiment, those genres (product classifications) are units of products registered by the consumer. Each genre is assigned a unique product classification code. The consumer can appropriately select and register the genre of interest. The user record 81 includes the product classification codes corresponding to the number of registered products. The product classification code is an example of product identification information.

As described above, the user database 8 functions as a storage unit that stores the posting-person identification information for identifying a posting-person who posts information of a product via the network, i.e., the posting-person ID, and the product identification information for identifying a product to be retrieved, i.e., the product classification code, in association with the user identification information for identifying a consumer or a so-called user who uses the information terminal 5, i.e., the user ID.

Now, the description of FIG. 2 will be continued. The processor 11 has functions as a registration unit 111, a first detection unit 112, an extraction unit 113, an acceptance unit 114, a second detection unit 115, and an output unit 116. The registration unit 111 is a function of registering a posting-person ID of a posting-person and a product classification code of a product, which are input via the information terminal 5, in the user database 8 in association with a user ID set for the user of the information terminal 5.

The first detection unit 112 is a function of detecting a product, which is identified by the product classification code included in the user record 81, from information that is posted via the network by the posting-person identified by the posting-person ID included in the same user record 81. The extraction unit 113 is a function of extracting an image of the product detected by the first detection unit 112 from the information posted by the posting-person via the network. The output unit 116 has a function of outputting the image of the product extracted by the extraction unit 113 to the information terminal 5 having a terminal address included in the user record 81. The acceptance unit 114 is a function of accepting the product specified by the user of the information terminal 5 from among products whose images are output to the information terminal 5. The second detection unit 115 is a function of detecting, from the store site 4, sales information of the product accepted by the acceptance unit 114 from among products detected by the first detection unit 112. The output unit 116 is also a function of outputting the sales information of the product detected by the second detection unit 115 to the information terminal 5.

Those functions of the registration unit 111, the first detection unit 112, the extraction unit 113, the acceptance unit 114, the second detection unit 115, and the output unit 116 are implemented by information processing executed by the processor 11 according to a server program.

The server program is a kind of application software, which is stored in the main memory 12 or the auxiliary storage device 13. The method of installing the server program in the main memory 12 or the auxiliary storage device 13 is not particularly limited. The server program can be installed in the main memory 12 or the auxiliary storage device 13 by being recorded on a removable recording medium or distributed by communication via the communication network 2. The form of the recording medium is not limited as long as the recording medium can store programs and an apparatus can read the programs from the recording medium, like a CD-ROM or a memory card.

### Description of Configuration of Information Terminal

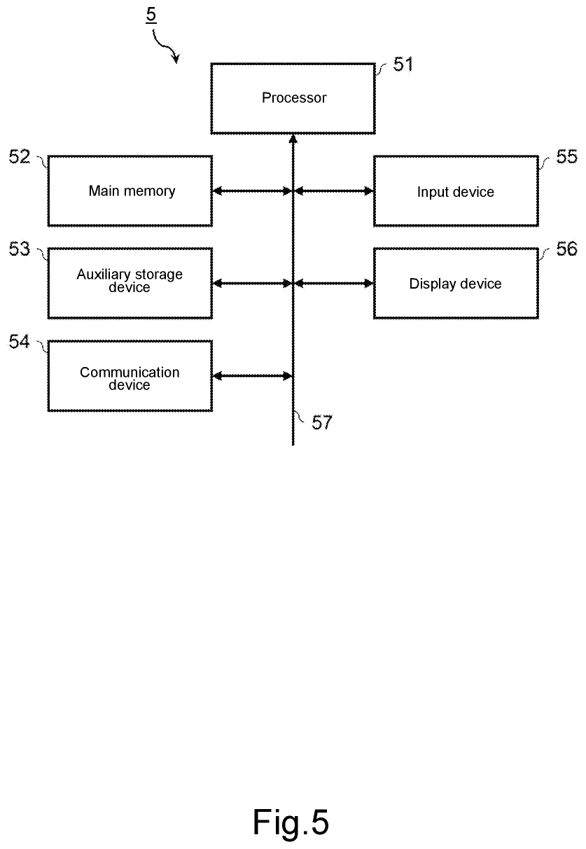

FIG. 5 is a block diagram showing a circuit configuration of a main part of the information terminal 5. The information terminal 5 includes a processor 51, a main memory 52, an auxiliary storage device 53, a communication device 54, an input device 55, a display device 56, and a system transmission path 57. The system transmission path 57 includes an address bus, a data bus, a control signal line, and the like. The information terminal 5 constitutes a computer by connecting the processor 51, the main memory 52, the auxiliary storage device 53, and the communication device 54 to each other via the system transmission path 57. The input device 55 and the display device 56 are connected to the computer via the system transmission path 57. The input device 55 is, for example, a keyboard. The display device 56 is, for example, a liquid crystal display. A touch panel having the functions of the input device 55 and the display device 56 may be connected to the computer.

The processor 51 corresponds to the central portion of the computer. The processor 51 controls the units so as to implement various functions as the information terminal 5 according to an operating system or an application program. The processor 51 is, for example, a CPU.

The main memory 52 corresponds to a main storage portion of the computer. The main memory 52 includes a nonvolatile memory area and a volatile memory area. The main memory 52 stores the operating system or application software in the nonvolatile memory area. The main memory 52 may store data, which is necessary for the processor 51 to execute processing for controlling the units, in the nonvolatile or volatile memory area. The volatile memory area of the main memory 52 is used as a work area in which data is appropriately rewritten by the processor 51. The nonvolatile memory area is, for example, a ROM. The volatile memory area is, for example, a RAM.

The auxiliary storage device 53 corresponds to an auxiliary storage portion of the computer. For example, an EEPROM, an HDD, an SSD, or the like can be the auxiliary storage device 53. The auxiliary storage device 53 stores data used by the processor 51 to perform various types of processing, data created in the processing by the processor 51, and the like. The auxiliary storage device 53 may store the application software.

The communication device 54 is a circuit that is connected to the communication network 2 to perform data communication. The information terminal 5 performs data communication with the posting-person site 3 via the communication device 54 and can thus display moving images, still images, and the like, which are provided by the posting-person site 3 using an SNS or the like, on the display device 56. Further, the information terminal 5 performs data communication with the store site 4 via the communication device 54, and can thus display a web page provided by the store site 4 on the display device 56.

The information terminal 5 having such a configuration stores the above-mentioned information retrieval application 6 in the main memory 52 or the auxiliary storage device 53. The method of installing the information retrieval application 6 in the main memory 52 or the auxiliary storage device 53 is not particularly limited. The information retrieval application 6 can be installed in the main memory 52 or the auxiliary storage device 53 by being recorded on a removable recording medium or distributed by communication via the communication network 2. The form of the recording medium is not limited as long as the recording medium can store programs and an apparatus can read the programs from the recording medium, like a CD-ROM or a memory card.

### Description of Actions of Information Retrieval Server and Information Terminal

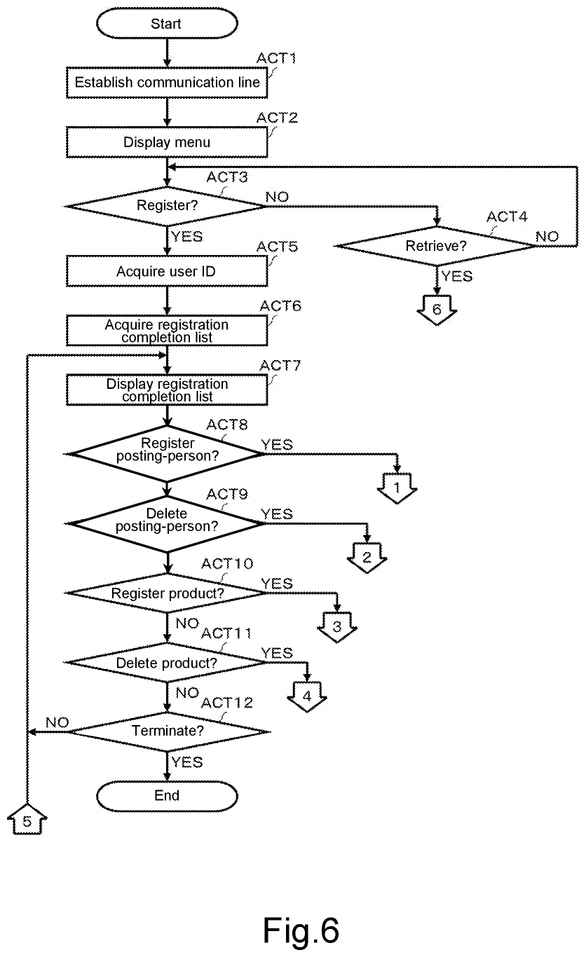

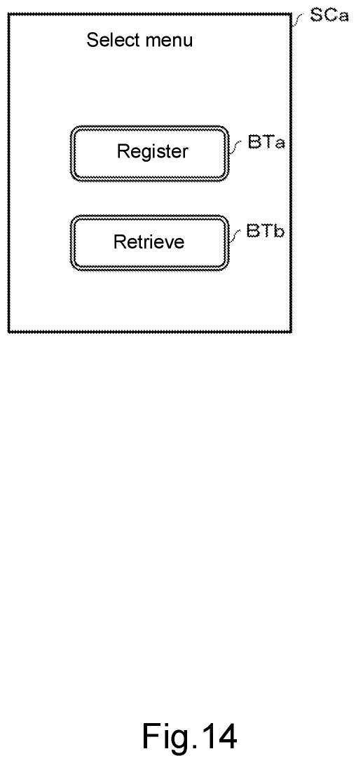

Next, the actions of the information terminal 5 and the information retrieval server 1 will be described using flowcharts shown in FIGS. 6 to 13 and exemplary display screens shown in FIGS. 14 to 20. Note that the following description is an example. If similar effects can be produced, the contents, procedures, and the like can be appropriately changed. Further, the display screens are also examples. Contents of text to be output, arrangement of images, kinds and layout of software keys, and the like can be appropriately changed.

FIGS. 6 to 9 are flowcharts showing main information processing that is executed by the processor 51 of the information terminal 5 according to the information retrieval application 6. When a user of the information terminal 5 activates the information retrieval application 6, in ACT1 of FIG. 6, the processor 51 controls the communication device 54 to establish a communication line with the information retrieval server 1. When the communication line with the information retrieval server 1 is established, the processor 51 displays a menu screen SCa (see FIG. 14) on the display device 56 in ACT2.

FIG. 14 is a display example of the menu screen SCa. The menu screen SCa displays a registration button BTa and a retrieval button BTb. The registration button BTa is an operation element for selecting a registration menu. The retrieval button BTb is an operation element for selecting a retrieval menu. The registration button BTa and the retrieval button BTb are software keys.

In such a manner, the information terminal 5 in which the information retrieval application 6 is activated can select the registration menu and the retrieval menu. The registration menu is a menu executed when the user of the information terminal 5 registers an influencer whose interests and preferences match with those of the user and a genre of a product that the user is interested in. The retrieval menu is a menu executed when the user of the information terminal 5 obtains sales information of a product that the user of the information terminal 5 is interested in. The user who uses the registration menu operates the registration button BTa. The user who uses the retrieval menu operates the retrieval button BTb.

The processor 51 of the information terminal 5, which has displayed the menu screen SCa, waits for the registration button BTa to be operated in ACT3 or the retrieval button BTb to be operated in ACT4. If the registration button BTa is operated in the standby state of ACT3 and ACT4, the processing of the processor 51 proceeds to ACT5. The processor 51 acquires the user ID of the user in ACT5. The user ID is stored in the main memory 52 or the auxiliary storage device 53 together with the information retrieval application 6, for example. The processor 51 acquires the user ID of the user from the main memory 52 or the auxiliary storage device 53.

In ACT6, the processor 51, which has acquired the user ID, acquires a registration completion list. The registration completion list is a list of posting-persons and products that have been already registered by the user of the information terminal 5. Information on the posting-persons and products that have been already registered in the previous registration menu processing is stored in, for example, the main memory 52 or the auxiliary storage device 53. The processor 51 acquires the registration completion list from the main memory 52 or the auxiliary storage device 53.

The registration completion list can also be acquired from the data of the user record 81 stored in the user database 8. The processor 51 requests the user record 81 from the information retrieval server 1 by using the user ID acquired in the processing of ACT5. Since the user record 81 including the user ID is transmitted from the information retrieval server 1 in response to the request, the processor 51 may acquire the registration completion list from the user record 81.

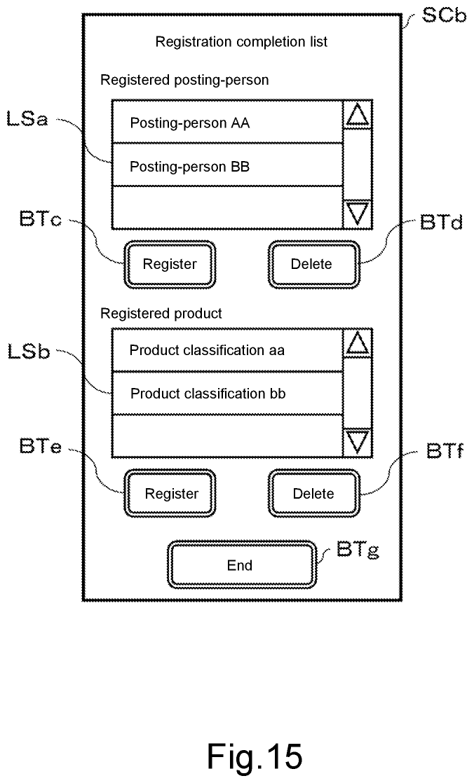

In ACT7, the processor 51, which has acquired the registration completion list, displays a registration completion list screen SCb (see FIG. 15) on the display device 56 on the basis of the data of the registration completion list.

FIG. 15 is a display example of the registration completion list screen SCb. The registration completion list screen SCb displays a posting-person list LSa in which a posting-person name of a registered posting-person is described, and a product list LSb in which a product classification name of a registered product is described. The registration completion list screen SCb displays a registration button BTc and a deletion button BTd in association with the posting-person list LSa. The registration button BTc is an operation element for selecting a posting-person registration mode. The deletion button BTd is an operation element for selecting a posting-person deletion mode. Further, the registration completion list screen SCb displays a registration button BTe and a deletion button BTf in association with the product list LSb. The registration button BTe is an operation element for selecting a product registration mode. The deletion button BTf is an operation element for selecting a product deletion mode. The registration completion list screen SCb displays an end button BTg. The end button BTg is an operation element for the user to declare the end of the registration menu. The registration button BTc, the deletion button BTd, the registration button BTe, the deletion button BTf, and the end button BTg are all software keys.

The user who registers a new posting-person operates the registration button BTc. The user who deletes the registered posting-person selects a posting-person name of a posting-person to be deleted from the posting-person list LSa and operates the deletion button BTd. The user who registers a new product operates the registration button BTe. The user who deletes the registered product selects a product classification name of a product to be deleted from the product list LSb and operates the deletion button BTf. The user who terminates the registration menu operates the end button BTg.

The processor 51 of the information terminal 5, which has displayed the registration completion list screen SCb, waits until the posting-person registration mode is selected in ACT8, the posting-person deletion mode is selected in ACT9, the product registration mode is selected in ACT10, the product deletion mode is selected in ACT11, or the end of the registration menu is declared in ACT12.

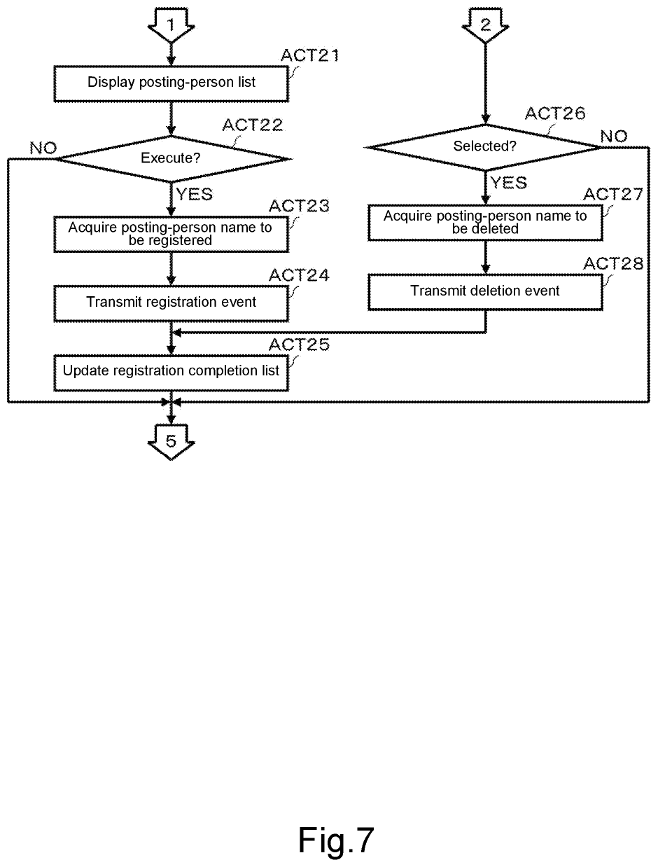

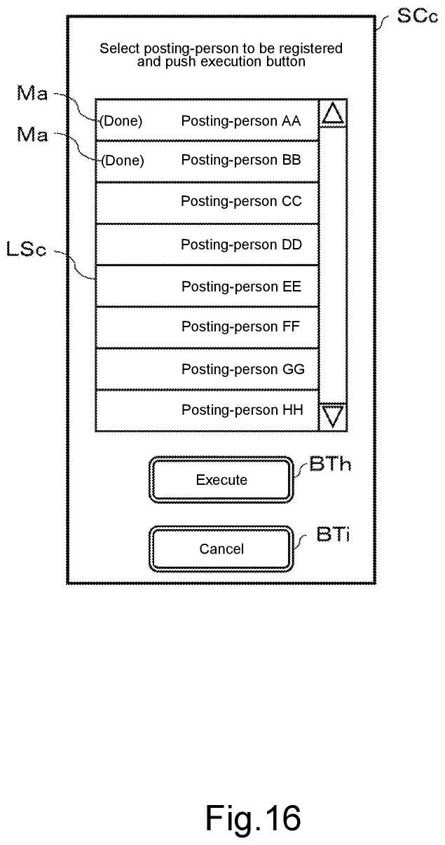

When the registration button BTc corresponding to the posting-person list LSa is operated in the standby state of ACT8 to ACT12, the processing of the processor moves to the posting-person registration mode. In other words, the processing of the processor 51 proceeds from ACT8 to ACT21 of FIG. 7. In ACT21, the processor 51 displays a posting-person list screen SCc (see FIG. 16) on the display device 56.

FIG. 16 is a display example of the posting-person list screen SCc. As shown in the figure, the posting-person list screen SCc displays the posting-person list LSa of each posting-person having the posting-person site 3. Further, the posting-person list screen SCc displays an execution button BTh and a cancel button BTi. The posting-person list LSa is a list in which the posting-person names of all the posting-person records 71 stored in the posting-person database 7 are arranged. The posting-person list LSa is downloaded from the information retrieval server 1 and displayed on the posting-person list screen SCc. A mark Ma indicating that the registration has been done is displayed for the posting-person who has already been registered in the information terminal 5.

The execution button BTh is an operation element for giving an instruction to register a posting-person. The cancel button BTi is an operation element for giving an instruction to cancel the posting-person registration mode. The user who has checked the posting-person list screen SCc selects a posting-person name of a posting-person to be newly registered from the posting-person list LSa and operates the execution button BTh. At that time, if two or more posting-persons are to be registered, the user selects the posting-person names of the two or more posting-persons and then operates the execution button BTh. If the registration of posting-persons is cancelled, the user operates the cancel button BTi.

In ACT22, the processor 51 of the information terminal 5, which has displayed the posting-person list screen SCc, checks whether or not the execution button BTh is operated. If the cancel button BTi is operated instead of the execution button BTh, the processing of the processor 51 returns from ACT22 to ACT7 of FIG. 6. The processor 51 displays again the registration completion list screen SCb as the screen of the display device 56 and enters the standby state of ACT8 to ACT12.

In ACT22, if at least one posting-person name is selected and the execution button BTh is operated, the processing of the processor 51 proceeds from ACT22 to ACT23. In ACT23, the processor 51 acquires the selected posting-person name. In ACT24, the processor 51 controls the communication device 54 to transmit a registration event. Through this control, the communication device 54 transmits the registration event. The registration event is transmitted to the information retrieval server 1 via the communication network. The registration event includes all the posting-person names acquired in ACT23.

The processing of the processor 51 of the information terminal 5, which has transmitted the registration event, proceeds to ACT25. In ACT25, the processor 51 updates the registration completion list. Specifically, the processor 51 adds the selected posting-person name to the registration completion list acquired in the processing of ACT6. Subsequently, the processing of the processor 51 returns to ACT7 of FIG. 6. The processor 51 displays again the registration completion list screen SCb as the screen of the display device 56 and enters the standby state of ACT8 to ACT12. In the registration completion list screen SCb at that time, the newly registered posting-person name is added to the posting-person list LSa.

In the standby state of ACT8 to ACT12, if the deletion button BTd corresponding to the posting-person list LSa is operated, the processing of the processor 51 moves to the posting-person deletion mode. In other words, the processing of the processor 51 proceeds from ACT9 to ACT26 of FIG. 7. In ACT26, the processor 51 checks whether or not at least one posting-person name is selected from the posting-person list LSa. If the deletion button BTd is operated without selecting posting-person names, the processing of the processor 51 proceeds from ACT26 to ACT7 of FIG. 6. The processor 51 maintains the registration completion list screen SCb on the display device 56 and enters the standby state of ACT8 to ACT12.

If the deletion button BTd is operated with at least one posting-person name being selected, the processing of processor 51 proceeds from ACT26 to ACT27. In ACT27, the processor 51 acquires the selected posting-person name. In ACT28, the processor 51 controls the communication device 54 to transmit a deletion event. Through this control, the communication device 54 transmits the deletion event. The deletion event is transmitted to the information retrieval server 1 via the communication network. The deletion event includes all the posting-person names acquired in ACT27.

The processing of the processor 51 of the information terminal 5, which has transmitted the deletion event, proceeds to ACT25. In ACT25, the processor 51 updates the registration completion list. Specifically, the processor 51 deletes the selected posting-person name from the registration completion list acquired in the processing of ACT6. Subsequently, the processing of the processor 51 returns to ACT7 of FIG. 6. The processor 51 updates the registration completion list screen SCb of the display device 56 and enters the standby state of ACT8 to ACT12. In the registration completion list screen SCb at that time, the selected posting-person name is deleted from the posting-person list LSa.

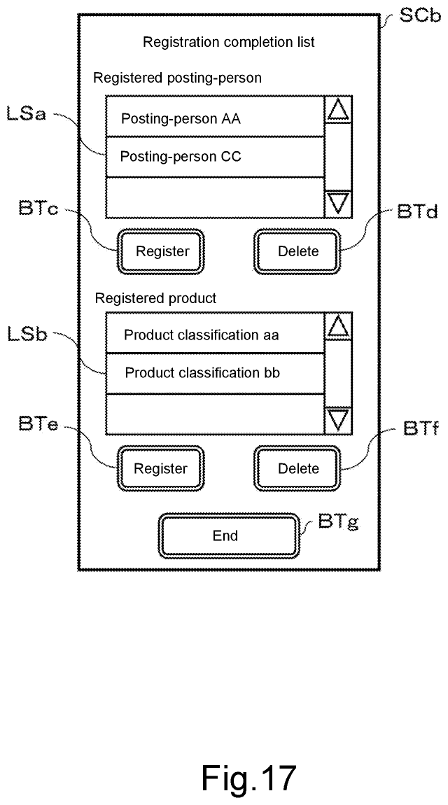

FIG. 17 is a registration completion list screen SCb obtained after a posting-person of a posting-person name “posting-person BB” is deleted from the posting-person list LSa, and a posting-person of a posting-person name “posting-person CC” is added thereto in the registration completion list screen SCb of FIG. 15. As shown in the figure, the posting-person name “posting-person BB” is deleted from the posting-person list LSa of the registration completion list screen SCb, and the posting-person name “posting-person CC” is added thereto.

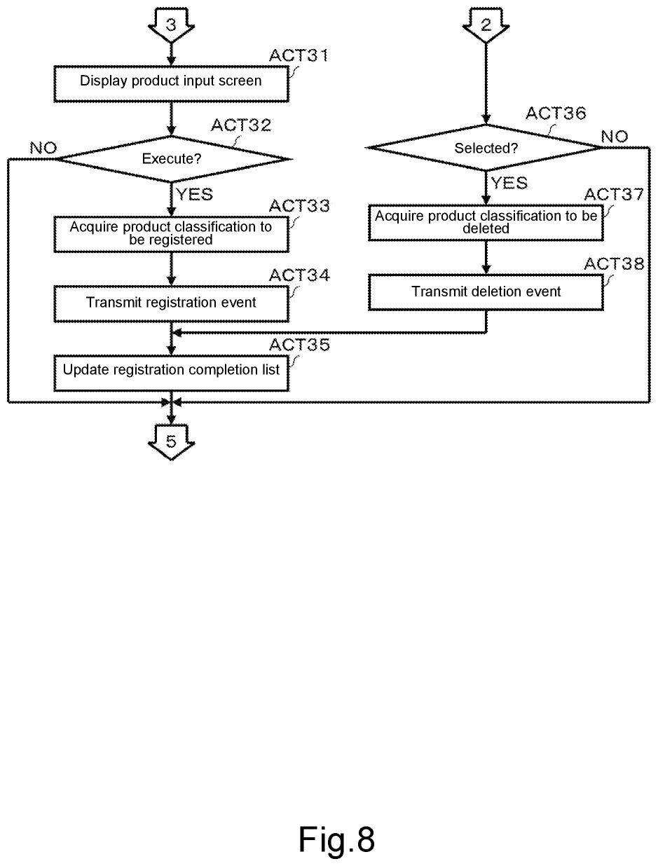

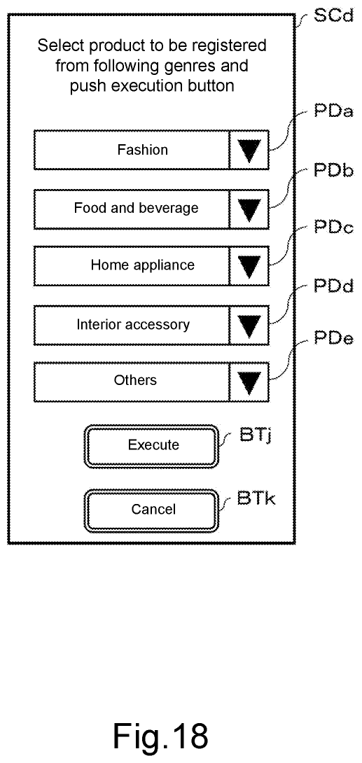

In the standby state of ACT8 to ACT12, if the registration button BTe corresponding to the product list LSb is operated, the processing of the processor 51 moves to the product registration mode. In other words, the processing of the processor 51 proceeds from ACT10 to ACT31 of FIG. 8. In ACT31, the processor 51 displays a product input screen SCd (see FIG. 18) on the display device 56.

FIG. 18 is a display example of the product input screen SCd. As shown in the figure, the product input screen SCd displays, for example, pull-down boxes PDa, PDb, PDc, PDd, and PDe respectively indicating the items of “fashion”, “food and beverage”, “home appliance”, “interior accessory”, and “others”. Further, the product input screen SCd displays an execution button BTj and a cancel button BTk. The pull-down box PDa is an area for displaying the name of a product classification, such as tops, bottoms, footwear, or accessories, belonging to the genre of the item “fashion” in the box in a selectable manner. The other pull-down boxes PDb, PDc, PDd, and PDe are also areas for displaying the name of a product classification belonging to the genre of the item in the box in a selectable manner.

The execution button BTj is an operation element for giving an instruction to register the product classification. The cancel button BTk is an operation element for giving an instruction to cancel the product registration mode. The user who has checked the product input screen SCd selects a product classification name of the product classification of interest from the product classification names respectively displayed in the pull-down boxes PDa, PDb, PDc, PDd, and PDe, and operates the execution button BTh. At that time, if the user is interested in two or more product classifications, the user selects the respective product classification names and then operates the execution button BTj. If the registration of the product classification is cancelled, the user operates the cancel button BTk.

In ACT32, the processor 51 of the information terminal 5, which has displayed the product input screen SCd, checks whether or not the execution button BTj is operated. If the cancel button BTk is input instead of the execution button BTj, the processing of the processor 51 returns from ACT32 to ACT7 of FIG. 6. The processor 51 displays again the registration completion list screen SCb as the screen of the display device 56 and enters the standby state of ACT8 to ACT12.

In ACT32, if at least one product classification name is selected and the execution button BTj is input, the processing of the processor 51 proceeds from ACT32 to ACT33. In ACT33, the processor 51 acquires the selected product classification name. In ACT34, the processor 51 controls the communication device 54 to transmit a registration event. Through this control, the communication device 54 transmits the registration event. The registration event is transmitted to the information retrieval server 1 via the communication network. The registration event includes all the product classification names acquired in ACT33.

The processing of the processor 51 of the information terminal 5, which has transmitted the registration event, proceeds to ACT35. In ACT35, the processor 51 updates the registration completion list. Specifically, the processor 51 adds the selected product classification name to the registration completion list acquired in the processing of ACT6. Subsequently, the processing of the processor 51 returns to ACT7 of FIG. 6. The processor 51 displays again the registration completion list screen SCb as the screen of the display device 56 and enters the standby state of ACT8 to ACT12. In the registration completion list screen SCb at that time, the newly registered product classification name is added to the product list LSb.

In the standby state of ACT8 to ACT12, if the deletion button BTf corresponding to the product list LSb is operated, the processing of the processor 51 moves to the product deletion mode. In other words, the processing of the processor 51 proceeds from ACT11 to ACT36 of FIG. 8. In ACT36, the processor 51 checks whether or not at least one product classification name is selected from the product list LSb. If the deletion button BTf is operated with no product classification names being selected, the processing of the processor 51 proceeds from ACT36 to ACT7 of FIG. 6. The processor 51 maintains the registration completion list screen SCb of the display device 56 and enters the standby state of ACT8 to ACT12.

If the deletion button BTf is operated with at least one product classification name being selected, the processing of processor 51 proceeds from ACT36 to ACT37. In ACT37, the processor 51 acquires the selected product classification name. In ACT38, the processor 51 controls the communication device 54 to transmit a deletion event. Through this control, the communication device 54 transmits the deletion event. The deletion event is transmitted to the information retrieval server 1 via the communication network. The deletion event includes all the product classification names acquired in ACT37.

The processing of the processor 51 of the information terminal 5, which has transmitted the deletion event, proceeds to ACT35. In ACT35, the processor 51 updates the registration completion list. Specifically, the processor 51 deletes the selected product classification name from the registration completion list acquired in the processing of ACT6. Subsequently, the processing of the processor 51 returns to ACT7 of FIG. 6. The processor 51 updates the registration completion list screen SCb of the display device 56 and enters the standby state of ACT8 to ACT12. In the registration completion list screen SCb at that time, the selected product classification name is deleted from the product list LSb.

If the end button BTg is operated (YES in ACT12) in the standby state of ACT8 to ACT12, the processor 51 terminates the information processing executed according to the information retrieval application 6.

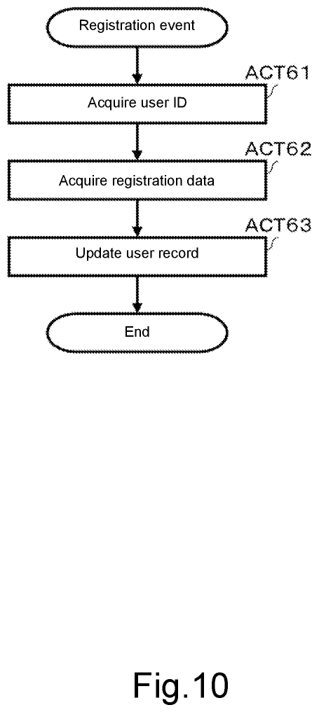

FIG. 10 is a flowchart showing main information processing executed by the processor 11 of the information retrieval server 1 that has received the registration event. Upon receiving the registration event via the communication interface 14, the processor 11 acquires an user ID from that registration event in ACT61. Further, the processor 11 receives registration data from that registration event in ACT62. If the received registration data is a registration event transmitted from the information terminal 5 as processing of the posting-person registration mode, the registration event includes a posting-person name. If the received registration data is a registration event transmitted from the information terminal 5 as processing of the product registration mode, the registration event includes a product classification name. In ACT63, the processor 11, which has acquired the registration data, updates the user record 81. In other words, if the registration data acquired in the processing of ACT62 includes the posting-person name, the processor 11 increments the number of registered posting-persons and adds a posting-person ID of a posting-person identified by the posting-person name to the user record 81 including the user ID acquired in the processing of ACT61. If the registration data acquired in the processing of ACT62 includes the product classification name, the processor 11 increments the number of registered products and adds a product classification code of a product classification identified by the product classification name. Through those steps, the processor 11 terminates the information processing performed when the registration event is received.

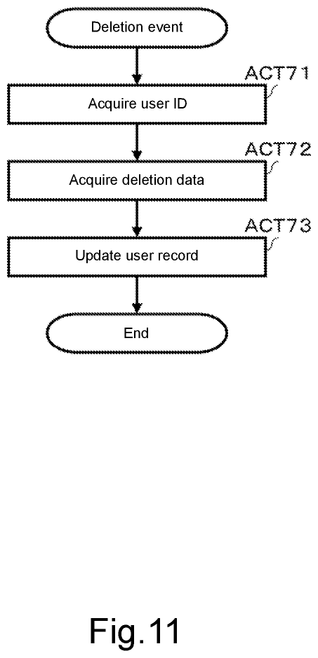

FIG. 11 is a flowchart showing main information processing executed by the processor 11 of the information retrieval server 1 that has received the deletion event. Upon receiving the deletion event via the communication interface 14, the processor 11 acquires an user ID from that deletion event in ACT71. Further, the processor 11 receives deletion data from that deletion event in ACT72. If the received deletion data is a deletion event transmitted from the information terminal 5 as processing of the posting-person deletion mode, the deletion event includes a posting-person name. If the received deletion data is a deletion event transmitted from the information terminal 5 as processing of the product deletion mode, the deletion event includes a product classification name. In ACT73, the processor 11, which has acquired the deletion data, updates the user record 81. In other words, if the deletion data acquired in the processing of ACT72 includes the posting-person name, the processor 11 decrements the number of registered posting-persons and deletes a posting-person ID of a posting-person identified by the posting-person name from the user record 81 including the user ID acquired in the processing of ACT71. If the deletion data acquired in the processing of ACT72 includes the product classification name, the processor 11 decrements the number of registered products and deletes a product classification code of a product classification identified by the product classification name. Through those steps, the processor 11 terminates the information processing performed when the deletion event is received.

As described above, the processor 11 performs the processing from ACT61 to ACT63 of FIG. 10 and the processing from ACT71 to ACT73 of FIG. 11, thus implementing the function as the registration unit 111.

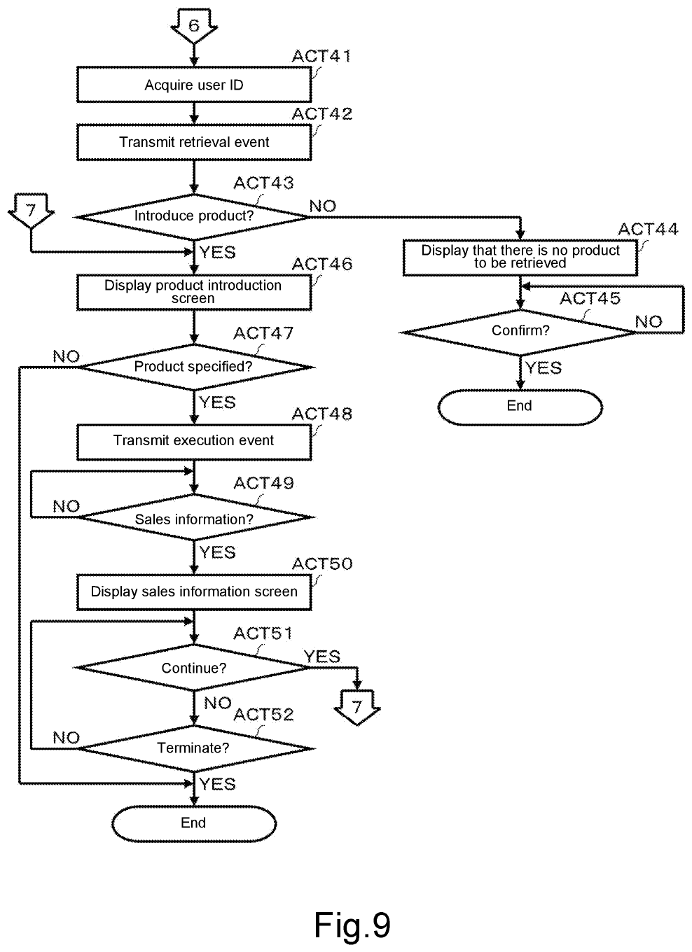

Now, the description of FIG. 6 will be continued. If the retrieval button BTb is operated in the standby state of ACT3 and ACT4, the processing of the processor 51 proceeds from ACT4 to ACT41 of FIG. 9. The processor 51 acquires the user ID of the user in ACT41. The processor 51 controls the communication device 54 to transmit a retrieval event as ACT42. Through this control, the communication device 54 transmits the retrieval event. The retrieval event is transmitted to the information retrieval server 1 via the communication network. The retrieval event includes the user ID acquired in ACT41.

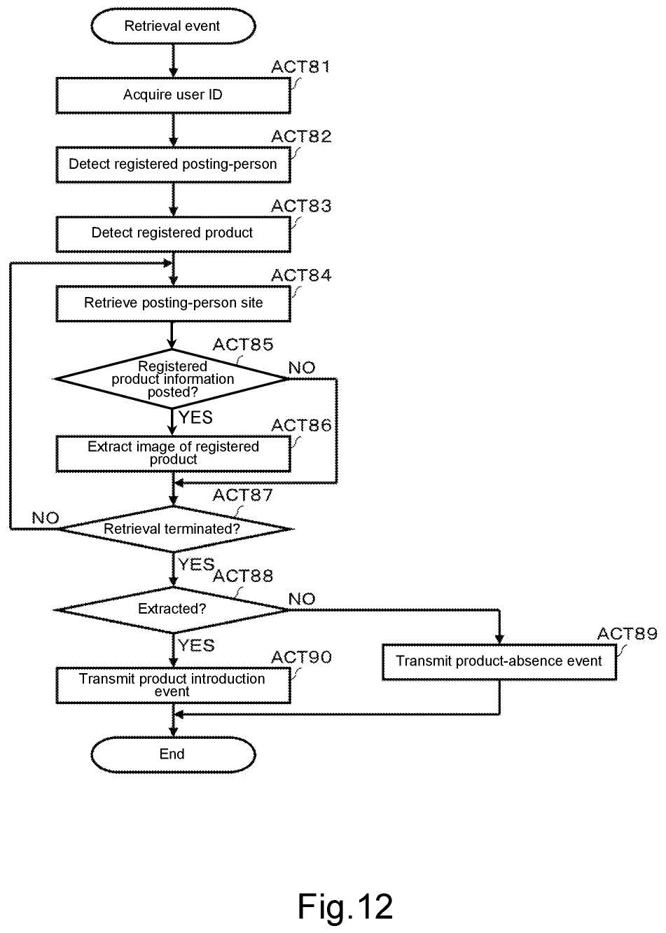

FIG. 12 is a flowchart showing main information processing executed by the processor 11 of the information retrieval server 1 that has received the retrieval event. Upon receiving the retrieval event via the communication interface 14, the processor 11 acquires an user ID from that retrieval event in ACT81. Subsequently, in ACT82, the processor 11 captures a user record 81 including the user ID from the user database 8, and detects posting-person IDs corresponding to the number of registered posting-persons from the user record 81. Further, in ACT83, the processor 11 detects product classification codes corresponding to the number of registered products from the user record 81.

In ACT84, the processor 11 retrieves information posted on a posting-person site 3 by a posting-person identified by the posting-person ID detected in the processing of ACT82, that is, a registered posting-person registered by the user. At that time, if two or more posting-person IDs are detected in ACT82, the processor 11 sequentially retrieves information posted on the posting-person sites 3 by the registered posting-persons respectively identified by the posting-person IDs. In the posting-person site 3, a posting-person called an influencer uses the functions of SNS such as Facebook (registered trademark), Twitter (registered trademark), Instagram (registered trademark), and YouTube (registered trademark) to post information of a product that the posting-person wants to introduce to consumers by using moving images or still images. In ACT85, the processor 11 checks whether or not there is a product belonging to the product classification code detected in the processing of ACT83, that is, a registered product registered by the user, from the information posted on the posting-person site 3. At that time, if the two or more product classification codes are detected in ACT83, the processor 11 checks whether or not there is a registered product belonging to each product classification code. Specifically, the processor 11 checks whether or not there is a registered product by analyzing an image or text of the product introduced by the registered posting-person. The processor 11 may also check whether or not there is a registered product by analyzing the voice of the registered posting-person introducing the product.

If the information posted on the posting-person site 3 contains the registered product, the processing of the processor 11 proceeds from ACT85 to ACT86. In ACT86, the processor 11 clips and extracts an image of the registered product from the information posted on the posting-person site 3. If the information posted on the posting-person site 3 does not contain the registered product, the processor 11 skips the processing of ACT86.

In ACT87, the processor 11 determines whether or not the retrieval of the posting-person site 3 is terminated. If the retrieval of the posting-person site 3 is not terminated, the processing of the processor 11 returns to ACT84. The processor 11 then executes the processing from ACT84 to ACT86 in the same manner as described above.

If all of the posting-person sites 3 of the registered posting-persons identified by the posting-person IDs detected in the processing of ACT82 are retrieved, the processing of the processor 11 proceeds to ACT88. In ACT88, the processor 11 determines whether or not an image of the registered product is extracted. If no images of the registered products can be extracted from the posting-person site 3 of the registered posting-person, the processor 11 proceeds from ACT88 to ACT89. In ACT89, the processor 11 controls the communication interface 14 to transmit a product-absence event. Through this control, a product-absence event is transmitted from the communication interface 14. The product-absence event is received by the information terminal 5 serving as a retrieval event transmission source via the communication network 2.

On the other hand, if an image of the registered product is extracted from the posting-person site 3 of the registered posting-person, the processing of the processor 11 proceeds from ACT88 to ACT90. In ACT90, the processor 11 controls the communication interface 14 to transmit a product introduction event. Through this control, the product introduction event is transmitted from the communication interface 14. The product introduction event is received by the information terminal 5 serving as the retrieval event transmission source via the communication network 2. The product introduction event includes a product image extracted by the processing of ACT86, a posting-person name related to the posting-person site 3 from which the product image is extracted, and a product classification name to which the product of the product image belongs.

In such a manner, the processor 11 of the information retrieval server 1, which has received the retrieval event, transmits the product-absence event or the product introduction event to the information terminal 5 serving as the retrieval event transmission source. Through those steps, the processor 11 terminates the information processing performed when the retrieval event is received.

As described above, the processor 11 implements the function as the first detection unit 112 by the processing from ACT81 to ACT87. Further, the processor 11 implements the function as the extraction unit 113 by the processing of ACT86.

Now, the description of FIG. 9 will be continued. The processor 51 of the information terminal 5, which has transmitted the retrieval event, waits for an event from the information retrieval server 1 in ACT43. Upon receiving a product-absence event, the processing of the processor 51 proceeds from ACT43 to ACT44. In ACT44, the processor 51 displays an image indicating that there is no product to be retrieved on the display device 56. This image includes, for example, a text indicating that there is no product to be retrieved. The image also includes a software key of a confirmation button. The user who has checked the image operates the confirmation button.

The processor 51 of the information terminal 5, which displays the image indicating that there is no product to be retrieved, waits until the confirmation button is operated in ACT45. If the confirmation button is operated (YES in ACT45), the processor 51 terminates the information processing executed according to the information retrieval application 6.

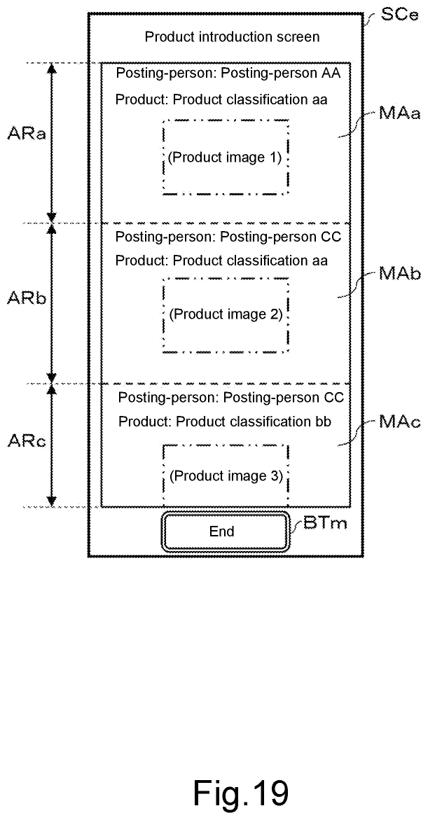

If the product introduction event is received in ACT43, the processing of the processor 51 proceeds to ACT46. In ACT46, the processor 51 displays a product introduction screen SCe (see FIG. 19) on the display device 56.

FIG. 19 is a display example of the product introduction screen SCe. As shown in the figure, the product introduction screen SCe displays one or more pieces of product information MAa, MAb, and MAc. Further, the product introduction screen SCe displays an end button BTm. The product information MAa, MAb, and MAc each include a product image, a posting-person name, and a product classification name included in the product introduction event. The end button BTm is an operation element for declaring the end of the product introduction screen SCe. The end button BTm is a software key. The display regions ARa, ARb, and ARc of the product information MAa, MAb, and MAc can be scrolled up and down. The user can browse all the product information MAa, MAb, and MAc by scrolling the display regions ARa, ARb, and ARc up and down.

The product information MAa, MAb, and MAc displayed on the product introduction screen SCe each indicate a product, which is introduced by the posting-person registered by the user and belongs to the product classification registered by the user. The user who has checked the product introduction screen SCe determines whether or not there is a product whose sales information is to be checked. If there is no product whose sales information is to be checked, the user operates the end button BTm. If there is a product whose sales information is to be checked, the user specifies the region ARa, ARb, or ARc in which the product information of the product is displayed. For example, if the display device 56 is a touch panel, the user touches any of the regions ARa, ARb, and ARc.

In ACT47, the processor 51 of the information terminal 5, which has displayed the product introduction screen SCe, waits until the region ARa, ARb, or ARc in which the product information is displayed is specified or until the end button BTm is operated. If the end button BTm is operated (NO in ACT47), the processor 51 terminates the information processing executed according to the information retrieval application 6.

If any of the regions ARa, ARb, and ARc is specified, the processing of the processor 51 proceeds from ACT47 to ACT48. In ACT48, the processor 51 controls the communication device 54 to transmit an execution event. Through this control, the communication device 54 transmits an execution event. The execution event is transmitted to the information retrieval server 1 via the communication network. The execution event includes the product information displayed in the specified region ARa, ARb, or ARc.

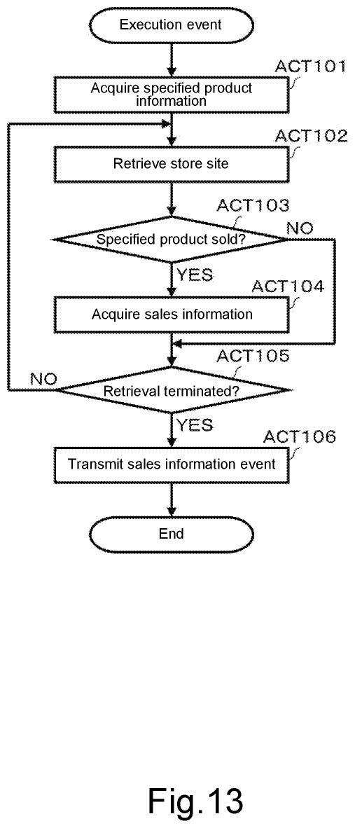

FIG. 13 is a flowchart showing main information processing executed by the processor 11 of the information retrieval server 1 that has received the execution event. Upon receiving the execution event via the communication interface 14, the processor 11 starts the processing of FIG. 13. In ACT101, the processor 11 acquires the product information specified by the execution event.

In ACT102, the processor 11 retrieves a store site 4 and extracts information of the store site 4 by, for example, a technique of web scraping. In ACT103, the processor 11 then determines whether or not the product of the product information specified by the execution event is sold at the store having the store site 4. For example, the processor 11 uses the image recognition technology that utilizes AI to check whether or not a product of an image having a feature point similar to that of the product image of the product information specified by the execution event is included in the information of the store site 4. If the similar product is included, the processor 11 recognizes that the product of the product information specified by the execution event is sold at the store having the store site 4.

If the product of the product information specified by the execution event is sold, the processing of the processor 11 proceeds from ACT103 to ACT104. In ACT104, the processor 11 acquires sales information of that product. In other words, the processor 11 acquires a store name of the store having the store site 4 and a URL of the store site 4. The processor 11 may include, in the sales information, the degree of similarity of an image having a feature point similar to that of the product image of the product information specified by the execution event. The processor 11 may acquire information such as a product name and a manufacturer name from the text posted on the web page of the store site 4, together with similar images, by using the technologies such as text mining, and may include the acquired information in the sales information.

If the sales information is acquired in ACT104 or if it is recognized in ACT103 that the product of the product information specified by the execution event is not sold at the store having the store site 4, the processing of the processor 11 proceeds to ACT105. In ACT105, the processor 11 checks whether or not the retrieval of the store site 4 is terminated. If the retrieval is not terminated, the processing of the processor 11 returns to ACT102. The processor 11 repeatedly executes the processing from ACT102 to ACT104 in the same manner as described above. Thus, on the basis of the information provided at each store site 4, the sales information such as the store name of the store where the product specified by the user is sold, the URL of the store site 4, the degree of similarity, the product name, and the manufacturer name is collected.

When the retrieval of the store site 4 is terminated, the processing of the processor 11 proceeds from ACT105 to ACT106. In ACT106, the processor 11 transmits a sales information event to the information terminal 5 serving as an execution event transmission source. The sales information event includes the sales information of the product, which has been acquired by the processing in ACT104. Through those steps, the processor 11 terminates the information processing performed when the execution event is received.

As described above, the processor 11 implements the function as the acceptance unit 114 by the processing of ACT101. The processor 11 implements the function as the second detection unit 115 by the processing from ACT102 to ACT105. The processor 11 implements the function as the output unit 116 by the processing of ACT106.

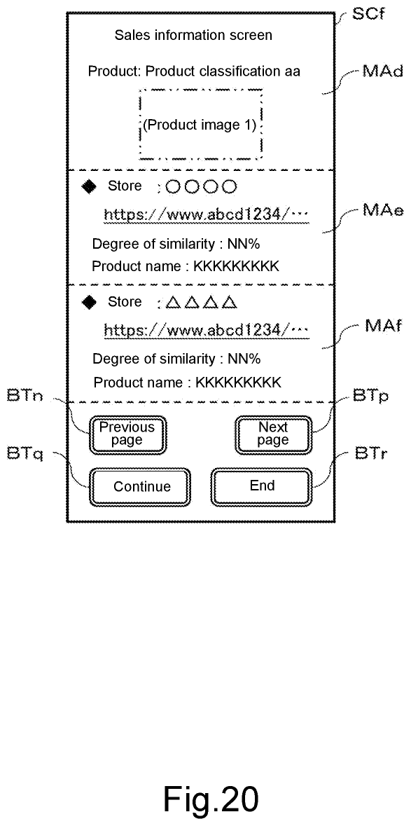

Now, the description of FIG. 9 will be continued. As ACT49, the processor 51 of the information terminal 5, which has transmitted the execution event, waits for a sales information event. If the processor 51 receives the sales information event, the processing of the processor 51 proceeds from ACT49 to ACT50. In ACT50, the processor 51 displays a sales information screen SCf (see FIG. 20) on the display device 56.

FIG. 20 is a display example of the sales information screen SCf. As shown in the figure, the sales information screen SCf displays product information MAd, which is displayed in the region ARa, ARb, or ARc specified by the user in the product introduction screen SCe. Further, the sales information screen SCf displays sales information MAe and MAf included in the sales information event. The sales information MAe and MAf include the store name of the store that sells the product of the product information MAd, the URL of the store site 4, the degree of similarity, the product name, the manufacturer name, and the like.

The sales information screen SCf displays a previous page button BTn, a next page button BTp, a continue button BTq, and an end button BTr. The previous page button BTn and the next page button BTp are operation elements for switching the pages of the sales information screen SCf. If the sales information MAe and MAf do not fit in one screen of the display device 56, the sales information screen SCf is a screen including a plurality of pages. The user can browse all the sales information MAe and MAf by operating the previous page button BTn and the next page button BTp. The continue button BTq is an operation element that is operated when the user wants to check the sales information of another product. The end button BTr is an operation element for declaring the end of the sales information screen SCf. The previous page button BTn, the next page button BTp, the continue button BTq, and the end button BTr are software keys.

Now, the description of FIG. 9 will be continued. The processor 51 of the information terminal 5, which has displayed the sales information screen SCf, waits until the continue button BTq is operated in ACT51 or until the end button BTr is operated in ACT52. If the continue button BTq is operated, the processing of the processor 51 returns from ACT51 to ACT46. The processor 51 then executes the processing of ACT46 and the following steps in the same manner as described above.

On the other hand, if the end button BTr is input (YES in ACT52), the processor 51 terminates the information processing executed according to the information retrieval application 6.

As described above in detail, according to the information retrieval system 100, a product that a consumer is interested in is automatically retrieved from information posted by an influencer preferred by the consumer, and sales information of that product is automatically retrieved, so that the consumer can immediately obtain information of a store that sells the favorite product posted by the influencer.

Further, the consumer can register, in the information retrieval server 1, an influencer whose interests and preferences match with those of the consumer and a genre of a product that the consumer is interested in, through a simple operation of the information terminal 5. Therefore, the consumer can use the information retrieval by the information retrieval system 100 in a meaningful manner.

An image of the product retrieved by the information retrieval system 100 is displayed on the information terminal 5 of the consumer. When the consumer specifies a product whose sales information is to be checked, the sales information of the product is displayed on the information terminal 5. Therefore, the consumer can acquire only sales information of a desired product from among the products retrieved by the information retrieval system 100.

### Modifications

One embodiment has been described above, but embodiments are not limited thereto. For example, the information retrieval server 1 stores information on the type of business of each store having the store site 4. The processor 11 then limits the store sites 4 to be retrieved in ACT102 of the execution event receiving processing to the stores of the type of business in which products of a product classification specified by a consumer are sold. This makes it possible to reduce the processing load for retrieval on the processor 11.

When registering in the information retrieval server 1 an influencer whose interests and preferences match with those of a consumer and a genre of a product that the consumer is interested in, the consumer does not necessarily have to use the information terminal 5.

Further, the information retrieval server 1 manages a user's history of browsing the posting-person sites 3 and the store sites 4 by using the information terminal 5. On the basis of the browsing history, a posting-person and a product that the user is interested in are specified, and a posting-person ID and a product classification code thereof are registered in the user database 8. This saves the consumer the effort of registering in the information retrieval server 1 an influencer whose interests and preferences match with those of the consumer and a genre of a product that the consumer is interested in.

In the embodiment described above, the information retrieval server 1 includes the posting-person database 7 and the user database 8. In this regard, the information retrieval server 1 does not necessarily have to include the posting-person database 7 and the user database 8. Apart from the information retrieval server 1, a database server including the posting-person database 7 and the user database 8 may be connected to the communication network 2, and the information retrieval server 1 may access the database server as necessary to obtain the posting-person record 71 and the user record 81.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information retrieval system, comprising:
an information terminal that is connected to a network and used by a consumer to search for a product;
a posting-person site that is connected to the network and used by a posting-person to post information of a product;
a store site that is connected to the network and used by a store to provide sales information of various products; and
an information retrieval server that is connected to the network and configured to
store posting-person identification information for identifying the posting-person and product identification information for identifying a product to be retrieved in association with user identification information for identifying the consumer,
detect the product identified by the product identification information stored in association with the user identification information, from information that is posted via the network by the posting-person site of the posting-person identified by the posting-person identification information stored in association with the user identification information,
detect sales information of the detected product from the store site, and
output the sales information of the detected product to the information terminal used by the consumer identified by the user identification information.

2. The information retrieval system according to claim 1, wherein
the information retrieval server includes
a communication interface that is connected to the network and performs data communication with the posting-person site or the store site via the network,
a storage device that includes a user database as an aggregate of user records created for each consumer who uses the information terminal, the user records including the user identification information, the posting-person identification information, and the product identification information,
a memory that stores an information retrieval program, and
a processor that executes the information retrieval program and is configured to
acquire the user identification information from the information terminal via the communication interface,
capture one of the user records that includes the acquired user identification information from the user database,
detect the posting-person identification information from the captured user record,
detect the product identification information from the captured user record,
retrieve information posted via the network by the posting-person site of the posting-person identified by the detected posting-person identification information,
check whether or not there is a product identified by the detected product identification information in the retrieved information,
detect sales information of the product, presence of the product being checked, from the store site, and
output the detected sales information of the product to the information terminal used by the consumer identified by the acquired user identification information.

3. The information retrieval system according to claim 1, wherein
the information terminal inputs the posting-person identification information of the posting-person and the product identification information of the product.

4. The information retrieval system according to claim 3, wherein
the information retrieval server stores the posting-person identification information of the posting-person and the product identification information of the product, the posting-person identification information and the product identification information being input by the information terminal, in association with the user identification information.

5. The information retrieval system according to claim 1, wherein
the information retrieval server extracts an image of the detected product from information posted by the posting-person site via the network.

6. The information retrieval system according to claim 5, wherein
the information retrieval server outputs the extracted image of the product to the information terminal used by the consumer identified by the user identification information.

7. The information retrieval system according to claim 6, wherein
the information terminal displays the image of the product, the image being output from the information retrieval server, and accepts a product for which the sales information is requested to be collected from products of the displayed image.

8. The information retrieval system according to claim 7, wherein
the information retrieval server detects the sales information of the accepted product from the store site.

9. The information retrieval system according to claim 1, wherein
the sales information of the product includes at least information related to a store site of a store that sells the product.

10. An information retrieval method for an information retrieval system, comprising:
storing posting-person identification information for identifying a posting-person of a posting-person site that provides information of a product via a network and product identification information for identifying a product to be retrieved in association with user identification information for identifying a consumer;
detecting the product identified by the product identification information stored in association with the user identification information, from information that is posted via the network by the posting-person site of the posting-person identified by the posting-person identification information stored in association with the user identification information;
detecting sales information of the detected product from the store site that provides sales information of various products; and
outputting the sales information of the detected product to an information terminal used by the consumer identified by the user identification information.
